(19) United States
(12) Patent Application Publication
(10) Pub. No.: US 2025/0056549 A1
(43) Pub. Date: Feb. 13, 2025

(54) METHOD AND APPARATUS FOR TRANSMITTING PHYSICAL DOWNLINK CONTROL CHANNEL, AND METHOD AND APPARATUS FOR RECEIVING PHYSICAL DOWNLINK CONTROL CHANNEL

(71) Applicant: Beijing Xiaomi Mobile Software co., Ltd., Beijing (CN)

(72) Inventor: Qun ZHAO, Beijing (CN)

(73) Assignee: Beijing Xiaomi Mobile Software co., Ltd., Beijing (CN)

(21) Appl. No.: 18/722,071

(22) PCT Filed: Dec. 29, 2021
(86) PCT No.: PCT/CN2021/142633

§ 371 Date: Jun. 20, 2024

(51) Int. Cl. H04W 72/23; H04L 5/00

(52) U.S. Cl. CPC H04W 72/23; H04L 5/0053

(57) ABSTRACT

A method, apparatus and transitory computer-readable storage medium for transmitting a physical downlink control channel (PDCCH). The transmitting of PDCCH is performed by: determining a first resource occupied by a long term evolution cell-specific reference signal (LTE CRS) and a second resource occupied by new radio physical downlink control channel (NR PDCCH) related information to be transmitted; determining that at least one resource element (RE) in the second resource conflicts with the first resource; adjusting the second resource and obtaining a third resource, wherein the third resource does not conflict with the first resource; and transmitting the NR PDCCH related information to a terminal on the third resource.

### CROSS-REFERENCE TO RELATED APPLICATIONS

The present application is a U.S. National Stage of International Application No. PCT/CN2021/142633, filed on Dec. 29, 2021, the contents of all of which are incorporated herein by reference in their entireties for all purposes.

### BACKGROUND

A Long Term Evolution (LTE) system and a New Radio (NR) system can coexist in the same spectrum at present. The LTE system is required to continuously transmit a Cell-specific Reference Signal (CRS), which seriously interferes with the NR system.

### SUMMARY

The disclosure relates to the field of communication technology, and particularly relates to a method for transmitting a physical downlink control channel, a method for receiving a physical downlink control channel, an apparatus for transmitting a physical downlink control channel, an apparatus for receiving a physical downlink control channel, a communication apparatus, and a computer-readable storage medium.

According to a first aspect of an example of the disclosure, a method for transmitting a physical downlink control channel is provided. The method is performed by a network-side device and includes: determining a first resource occupied by a long term evolution cell-specific reference signal (LTE CRS) and a second resource occupied by new radio physical downlink control channel (NR PDCCH) related information to be transmitted; determining that at least one resource element (RE) in the second resource conflicts with the first resource; adjusting the second resource and obtaining a third resource, where the third resource does not conflict with the first resource; and transmitting the NR PDCCH related information to a terminal on the third resource.

According to a second aspect of an example of the disclosure, a method for receiving a physical downlink control channel is provided. The method is performed by a terminal and includes: determining a first resource occupied by a long term evolution cell-specific reference signal (LTE CRS) and a second resource occupied by new radio physical downlink control channel (NR PDCCH) related information to be transmitted; determining that at least one resource element (RE) in the second resource conflicts with the first resource; determining a third resource obtained after the second resource is adjusted, where the third resource does not conflict with the first resource; and receiving, on the third resource, the NR PDCCH related information transmitted by a network-side device.

According to a third aspect of an example of the disclosure, a communication apparatus is provided. The communication apparatus includes one or more processors; and a memory configured to store a computer program. The computer program when executed by the one or more processors causes the one or more processors to collectively:: determine a first resource occupied by a long term evolution cell-specific reference signal (LTE CRS) and a second resource occupied by new radio physical downlink control channel (NR PDCCH) related information to be transmitted; determine that at least one resource element (RE) in the second resource conflicts with the first resource; adjust the second resource and obtaining a third resource, wherein the third resource does not conflict with the first resource; and transmit the NR PDCCH related information to a terminal on the third resource.

According to a fourth aspect of an example of the disclosure, a communication apparatus is provided. The communication apparatus includes one or more processors; and a memory configured to store a computer program. The one or more processors are collectively configured to execute the computer program, so as to perform the method for receiving the physical downlink control channel.

According to a fifth aspect of an example of the disclosure, a non-transitory computer-readable storage medium is provided. The computer-readable storage medium is configured to store a computer program. The computer program when executed by one or more processors cause the one or more processors to collectively execute the method for transmitting the physical downlink control channel.

According to a sixth aspect of an example of the disclosure, a non-transitory computer-readable storage medium is provided. The computer-readable storage medium is configured to store a computer program. The computer program when executed by one or more processors cause the one or more processors to collectively execute the method for receiving the physical downlink control channel.

### BRIEF DESCRIPTION OF DRAWINGS

In order to describe technical solutions in examples of the disclosure more clearly, accompanying drawings required to be used in descriptions of the examples will be briefly introduced below. Apparently, the accompanying drawings in the following descriptions show some examples of the disclosure. Those of ordinary skill in the art would also be able to derive other accompanying drawings according to these accompanying drawings without making creative efforts.

FIG. 1 is a schematic flow diagram of a method for transmitting a physical downlink control channel according to an example of the disclosure.

FIG. 2 is a schematic diagram of a first resource according to an example of the disclosure.

FIG. 3 is a schematic flow diagram of another method for transmitting a physical downlink control channel according to an example of the disclosure.

FIG. 4 is a schematic flow diagram of yet another method for transmitting a physical downlink control channel according to an example of the disclosure.

FIG. 5 is a schematic diagram showing that a resource element (RE) corresponding to new radio physical downlink control channel demodulation reference signal (NR PDCCH DMRS) conflicts with a first resource according to an example of the disclosure.

FIG. 6 is a schematic flow diagram of yet another method for transmitting a physical downlink control channel according to an example of the disclosure.

FIG. 7 is a schematic diagram of a third resource according to an example of the disclosure.

FIG. 8 is a schematic flow diagram of yet another method for transmitting a physical downlink control channel according to an example of the disclosure.

FIG. 9 is a schematic diagram of another third resource according to an example of the disclosure.

FIG. 10 is a schematic flow diagram of yet another method for transmitting a physical downlink control channel according to an example of the disclosure.

FIG. 11 is a schematic diagram of yet another third resource according to an example of the disclosure.

FIG. 12 is a schematic flow diagram of still another method for transmitting a physical downlink control channel according to an example of the disclosure.

FIG. 13 is a schematic diagram of still another third resource according to an example of the disclosure.

FIG. 14 is a schematic flow diagram of a method for receiving a physical downlink control channel according to an example of the disclosure.

FIG. 15 is a schematic flow diagram of another method for receiving a physical downlink control channel according to an example of the disclosure.

FIG. 16 is a schematic flow diagram of yet another method for receiving a physical downlink control channel according to an example of the disclosure.

FIG. 17 is a schematic flow diagram of yet another method for receiving a physical downlink control channel according to an example of the disclosure.

FIG. 18 is a schematic flow diagram of yet another method for receiving a physical downlink control channel according to an example of the disclosure.

FIG. 19 is a schematic flow diagram of yet another method for receiving a physical downlink control channel according to an example of the disclosure.

FIG. 20 is a schematic flow diagram of still another method for receiving a physical downlink control channel according to an example of the disclosure.

FIG. 21 is a schematic block diagram of an apparatus for transmitting a physical downlink control channel according to an example of the disclosure.

FIG. 22 is a schematic block diagram of an apparatus for receiving a physical downlink control channel according to an example of the disclosure.

FIG. 23 is a schematic block diagram of an apparatus for transmitting a physical downlink control channel according to an example of the disclosure.

FIG. 24 is a schematic block diagram of an apparatus for receiving a physical downlink control channel according to an example of the disclosure.

### DETAILED DESCRIPTION

Technical solutions of examples of the disclosure will be clearly and completely described in combination with accompanying drawings of the examples of the disclosure. Apparently, the described examples are some examples rather than all examples of the disclosure. On the basis of examples of the disclosure, all other examples obtained by those of ordinary skill in the art without making creative efforts fall within the scope of protection of the disclosure.

Terms used in examples of the disclosure are intended to describe particular examples, and are not intended to limit examples of the disclosure. Singular forms such as “a,” “an,” and “this” used in examples of the disclosure and the appended claims are also intended to include plural forms, unless otherwise clearly stated in the context. It should also be understood that the term “and/or” used here refers to and includes any or all possible combinations of one or more of associated listed items.

It should be understood that although terms “first,” “second,” “third,” etc. may be employed in examples of the disclosure to describe all types of information, such information should not be limited to these terms. These terms are used to distinguish the same type of information from each other. For example, first information can also be referred to as second information, and similarly, second information can also be referred to as first information, without departing from the scope of examples of the disclosure. Depending on the context, the word “if” as used here can be interpreted as “in a case that,” “when” or “in response to determining.”

For purposes of concision and ease of understanding, the terms “greater than” or “less than” and “higher than,” or “lower than” are used here to represent size relations. Those skilled in that art can understand that the term “greater than” also encompasses the meaning of “greater than or equal to,” the term “less than” also encompasses the meaning of “less than or equal to,” the term “higher than” also encompasses the meaning of “higher than or equal to,” and the term “lower than” also encompasses the meaning of “lower than or equal to.”

In the related art, in order to avoid the situation that the LTE CRS seriously interferes with an NR Physical Downlink Control Channel (PDCCH) and impairs a performance of receiving the NR PDCCH by an NR device, it is specified that the NR device detects only a PDCCH candidate whose resources do not overlap those of the LTE CRS when receiving the NR PDCCH. However, a transmission performance and scheduling flexibility of the NR PDCCH will be severely restricted.

In view of this, an example of the disclosure provide a method for transmitting a physical downlink control channel, a method for receiving a physical downlink control channel, an apparatus for transmitting a physical downlink control channel, an apparatus for receiving a physical downlink control channel, a communication apparatus, and a computer-readable storage medium, so as to solve the technical problems in the related art.

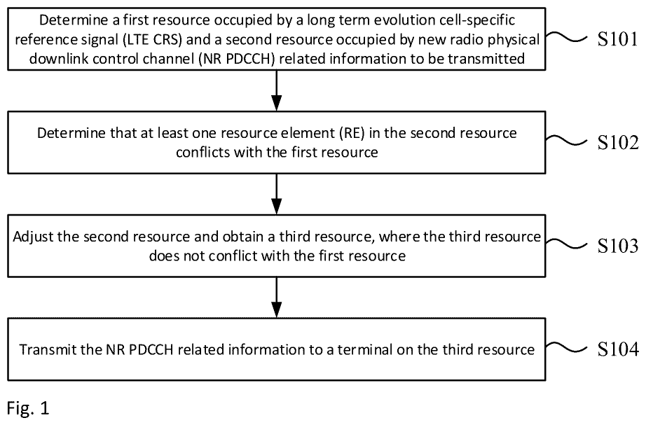

FIG. 1 is a schematic flow diagram of a method for transmitting a physical downlink control channel according to an example of the disclosure. The method for transmitting a physical downlink control channel shown in the example may be performed by a network-side device. The network-side device may be in communication with a terminal. The terminal includes but is not limited to communication apparatuses such as a mobile phone, a tablet computer, a wearable device, a sensor and an internet of things device. The network-side device includes but is not limited to network-side devices in 4th generation (4G), 5th generation (5G), 6th generation (6G) and other communication systems, such as base stations and core networks.

As shown in FIG. 1, the method for transmitting a physical downlink control channel may include steps as follows:

Step101, a first resource occupied by a long term evolution cell-specific reference signal (LTE CRS) and a second resource occupied by new radio physical downlink control channel (NR PDCCH) related information to be transmitted is determined.

Step S102, at least one resource element (RE) in the second resource that conflicts with the first resource is determined.

Step 103, the second resource is adjusted and a third resource is obtained, where the third resource does not conflict with the first resource.

Step 104, the NR PDCCH related information is transmitted to a terminal on the third resource.

According to examples of the disclosure, when it is determined that at least one resource element (RE) in the second resource conflicts with the first resource, the network-side device does not directly give up transmitting the NR PDCCH related information including the conflicting RE, but can adjust the second resource and obtain the third resource. Since the obtained third resource does not conflict with the first resource, the NR PDCCH related information is further transmitted on the third resource. In a case of ensuring that an RE in a resource corresponding to the NR PDCCH related information does not conflict with the first resource, an impact of the LTE CRS on the NR PDCCH related information is reduced, and a large number of REs that do not conflict with the first resource are prevented from being discarded such that a transmission performance and scheduling flexibility can be improved.

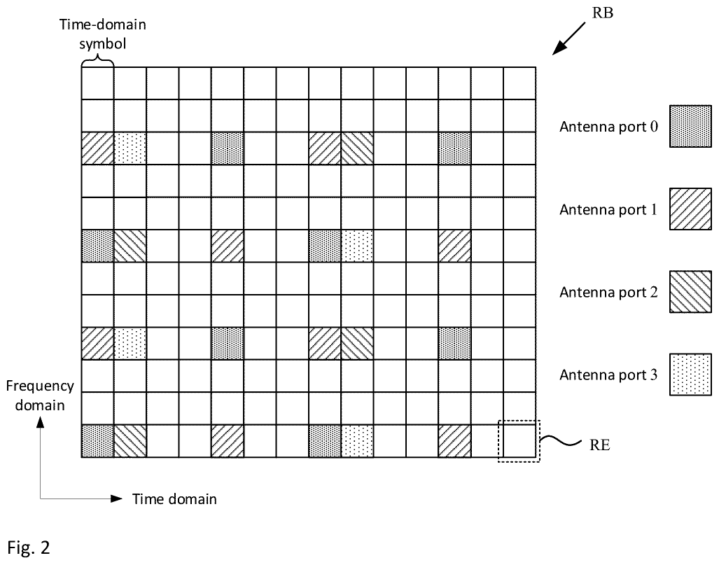

FIG. 2 is a schematic diagram of a first resource according to an example of the disclosure.

In an example, an example in which an LTE cell identity (Cell ID) is equal to 0, and an LTE CRS supports 4 ports, that is, antenna port 0, antenna port 1, antenna port 2 and antenna port 3 is taken. An LTE CRS corresponding to each antenna port occupies different resources. Resources occupied by LTE CRSs corresponding to the 4 antenna ports overlap each other to serve as a first resource.

As shown in FIG. 2, one resource block (RB) includes 14 symbols (such as orthogonal frequency division multiplexing (OFDM) symbols) in a time domain and 12 resource elements (RE) in a frequency domain. For example, on one symbol, numbers of the REs from bottom to top are RE#0 to RE#11. As shown in FIG. 2, the first resource occupies REs with numbers RE#0, RE#3, RE#6 and RE#9 on 1st, 2nd, 5th, 8th, 9th and 12th symbols.

It should be noted that the LTE CRS may be transmitted by an LTE network-side device. The NR PDCCH related information may be transmitted by an NR network-side device. The NR network-side device may determine the second resource occupied by the NR PDCCH related information. The NR network-side device may also determine the first resource occupied by the LTE CRS. For example, the first resource can be determined through communication with the LTE network-side device, or the first resource can also be determined based on a protocol.

In addition, the terminal may also determine the first resource and the second resource. For example, the terminal may determine the first resource based on the protocol, determine the second resource based on the protocol, or determine the second resource according to an NR network-side device configuration.

In the related art, since the first resource occupied by the LTE CRS is determined, it is difficult for the NR network-side device to change the first resource. When it is determined that at least one RE in the second resource occupied by the NR PDCCH related information conflicts with the first resource, for example, at least one RE in the second resource overlaps at least one RE in the first resource, the terminal will not receive the NR PDCCH related information including this overlapping RE. Accordingly, the NR network-side device will not transmit the NR PDCCH related information including this overlapping RE.

In an example, the NR PDCCH related information includes at least one of:
an NR PDCCH demodulation reference signal (DMRS) of an NR PDCCH; or
downlink control information (DCI) carried by the NR PDCCH.

In a case that the NR PDCCH related information includes the DCI, the terminal in the related art does not expect to receive a PDCCH candidate including this overlapping RE. Accordingly, the NR network-side device does not transmit the PDCCH candidate including this overlapping RE.

Since the PDCCH candidate does not only include individual REs, but includes at least one control channel element (CCE). One CCE includes a large number of REs. The NR network-side device does not transmit the PDCCH candidate including this overlapping RE, it is indicated that if a PDCCH candidate that the NR network-side device originally is required to transmit includes this overlapping RE, the entire PDCCH candidate is not transmitted. As a result, no DCI is transmitted on all CCEs (in which an RE that does not conflict with the first resource may exist) included in the PDCCH candidate. Thus, a large number of REs (such as REs that do not conflict with the first resource) are not used, and a transmission performance and scheduling flexibility of the NR PDCCH are severely restricted.

According to examples of the disclosure, when it is determined that at least one resource element (RE) in the second resource conflicts with the first resource, the network-side device does not directly give up transmitting the NR PDCCH related information including the conflicting RE, but can adjust the second resource and obtain the third resource. Since the obtained third resource does not conflict with the first resource, the NR PDCCH related information is further transmitted on the third resource. In a case of ensuring that an RE in a resource corresponding to the NR PDCCH related information does not conflict with the first resource, an impact of the LTE CRS on the NR PDCCH related information is reduced, and a large number of REs that do not conflict with the first resource are prevented from being discarded such that a transmission performance and scheduling flexibility can be improved.

It should be noted that a method through which the network-side device adjusts the second resource and obtains the third resource may be indicated to the terminal by the network-side device. For example, the method may be indicated to the terminal via system information, paging signaling, etc. Alternatively, the method may be determined based on a protocol. For example, the terminal may also determine, based on a protocol, the method through which the network-side device adjusts the second resource and obtains the third resource.

For example, in a case that at least one resource element (RE) in the second resource conflicts with the first resource, a terminal may determine a third resource obtained after the second resource is adjusted, and further receive the NR PDCCH related information on the third resource transmitted by the network-side device. The terminal may determine, according to an indication of the network-side device or according to a protocol, how to adjust the second resource and obtain the third resource.

With respect to the NR PDCCH related information, the NR PDCCH DMRS and the DCI are mainly taken as examples in examples of the disclosure. During practical application, examples of the disclosure may also be applied to other NR PDCCH related information according to requirements. A case that the NR PDCCH related information includes the DCI will be illustratively described below through several examples.

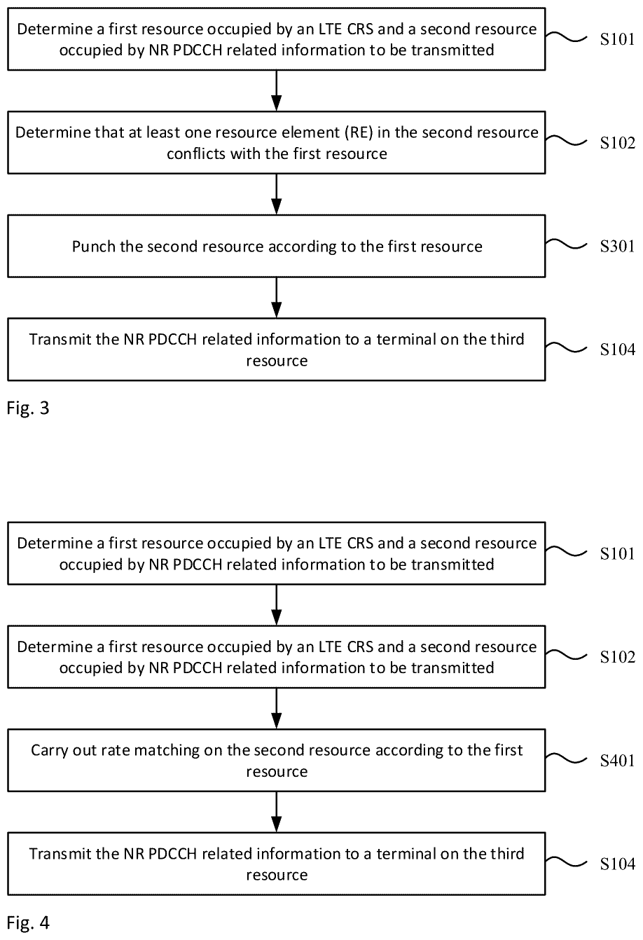

FIG. 3 is a schematic flow diagram of another method for transmitting a physical downlink control channel according to an example of the disclosure. As shown in FIG. 3, in a case that the NR PDCCH related information includes the DCI, the steps of adjusting the second resource and obtaining a third resource include:

Step 301, the second resource is punched according to the first resource.

In an example, the network-side device may punch the second resource according to the first resource, for example, remove a RE that conflicts with the first resource from the second resource through punching, the remaining resources may serve as the third resources. That is, for the network-side device, the DCI is transmitted on an RE in the second resource that does not conflict with the first resource, this operation process is relatively simple and easy to implement.

Since the network-side device executes a transmitting operation, and the terminal executes a receiving operation, in a case that the network-side device punches the second resource according to the first resource, a specific operation of punching the second resource by the terminal according to the first resource may be different from a specific operation by the network-side device. For example, the terminal receives the DCI on the second resource regardless of existence of the LTE CRS.

FIG. 4 is a schematic flow diagram of yet another method for transmitting a physical downlink control channel according to an example of the disclosure. As shown in FIG. 4, the steps of adjusting the second resource and obtaining a third resource include:

Step 401, rate matching (RM) is carried out on the second resource according to the first resource.

In an example, the network-side device may carry out rate matching on the second resource according to the first resource, for example, determine an RE in the second resource that does not conflict with the first resource as the third resource, and then transmit the DCI on the third resource. Correspondingly, the terminal may determine the RE in the second resource that does not conflict with the first resource as the third resource, and then receive the DCI on the third resource.

A case that the NR PDCCH related information includes the NR PDCCH DMRS will be illustratively described below through several examples.

It should be noted that the DCI in the above example is information carried by the NR PDCCH, while the NR PDCCH DMRS is not information carried by the NR PDCCH but is information configured to demodulate the NR PDCCH. However, in some cases, the NR PDCCH DMRS may also be set in the control resource set (CORESET) where the NR PDCCH is located, so as to be transmitted. Thus, the RE corresponding to the NR PDCCH DMRS and the RE corresponding to the DCI may both conflict with the first resource.

When the DCI is transmitted, even if the RE corresponding to the DCI conflicts with the first resource, the DCI may be transmitted through punching or rate matching. However, when the RE corresponding to the NR PDCCH DMRS conflicts with the first resource, the NR PDCCH DMRS cannot be transmitted through punching or rate matching, and other methods are required to be considered to determine the third resource.

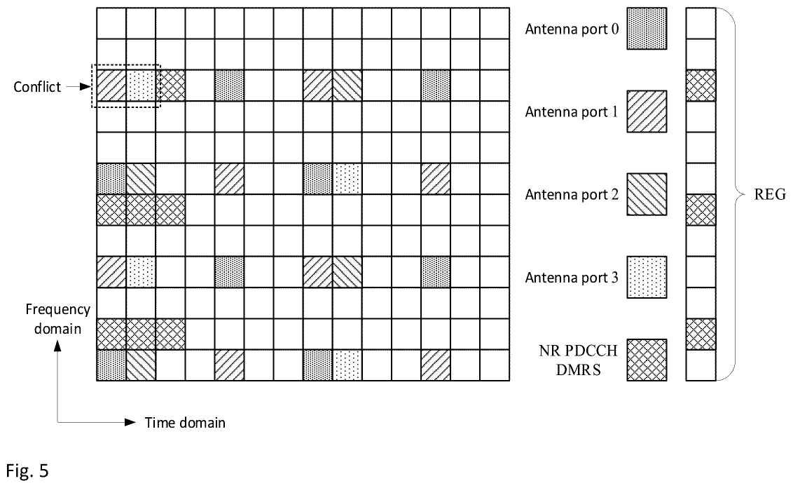

FIG. 5 is a schematic diagram showing that a resource element (RE) corresponding to new radio physical downlink control channel demodulation reference signal (NR PDCCH DMRS) conflicts with a first resource according to an example of the disclosure.

As shown in FIG. 5, in a resource element group (REG) in the NR, a pattern (pattern) of the NR PDCCH DMRSs is that the NR PDCCH DMRSs are distributed in RE#1, RE#5 and RE#9.

For example, if the duration (duration) of the CORESET is 3 time-domain symbols, that is, the first 3 symbols in the RB, when the NR PDCCH DMRS is located in the CORESET, the second resource conflicts with the first resource on RE#9 of the first 2 symbols in the RB.

A case that the NR PDCCH related information includes the NR PDCCH DMRS will be illustratively described below mainly based on an example shown in FIG. 5.

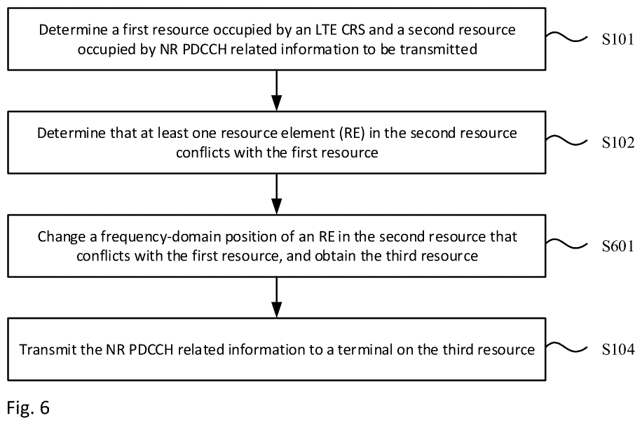

FIG. 6 is a schematic flow diagram of yet another method for transmitting a physical downlink control channel according to an example of the disclosure. As shown in FIG. 6, in a case that the NR PDCCH related information includes the NR PDCCH DMRS, the steps of adjusting the second resource and obtaining a third resource include:

Step 601, a frequency-domain position of the RE in the second resource that conflicts with the first resource is changed (specifically, a frequency-domain position where the conflicting RE carries the NR PDCCH DMRS is changed), and the third resource is obtained.

In an example, the network-side device may change the frequency-domain position of the RE in the second resource that conflicts with the first resource, for example, move the frequency-domain position of the RE in the second resource that conflicts with the first resource to a high frequency or a low frequency. A moving distance may be one or more REs. A specific method for changing the frequency-domain position may be determined according to an indication of the network-side device, or may be determined based on a protocol.

Accordingly, on the basis that an RE corresponding to the NR PDCCH DMRS does not conflict with an RE corresponding to the LTE CRS, a number of NR PDCCH DMRSs carried on each REG can be ensured unchanged such that a performance of demodulating the NR PDCCH based on the NR PDCCH DMRS can be ensured.

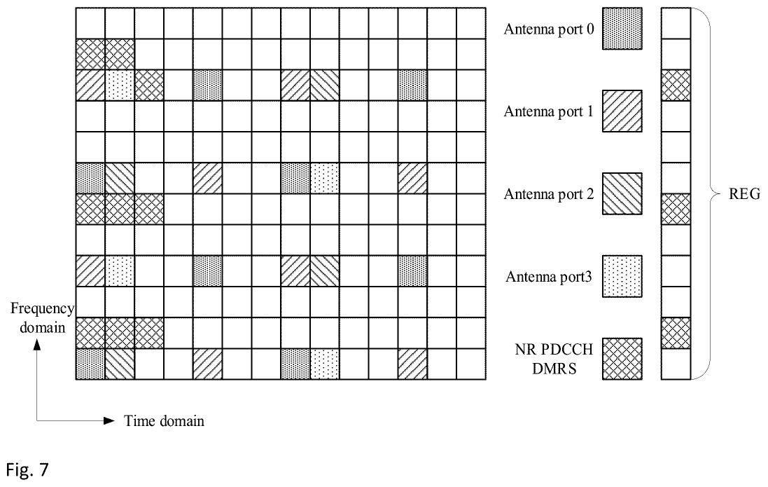

FIG. 7 is a schematic diagram of a third resource according to an example of the disclosure.

As shown in FIG. 7, if the second resource conflicts with the first resource on RE#9 of the first 2 symbols in the RB, the frequency-domain position of the second resource on the two REs may be changed. For example, the second resource is moved from RE#9 to RE#10. That is, the NR PDCCH DMRS is changed from being carried by an RE corresponding to RE#9 to an RE corresponding to RE#10. Accordingly, 3 REs still exist on each REG to be configured to carry the NR PDCCH DMRSs such that a performance of demodulating the NR PDCCH based on the NR PDCCH DMRS can be ensured.

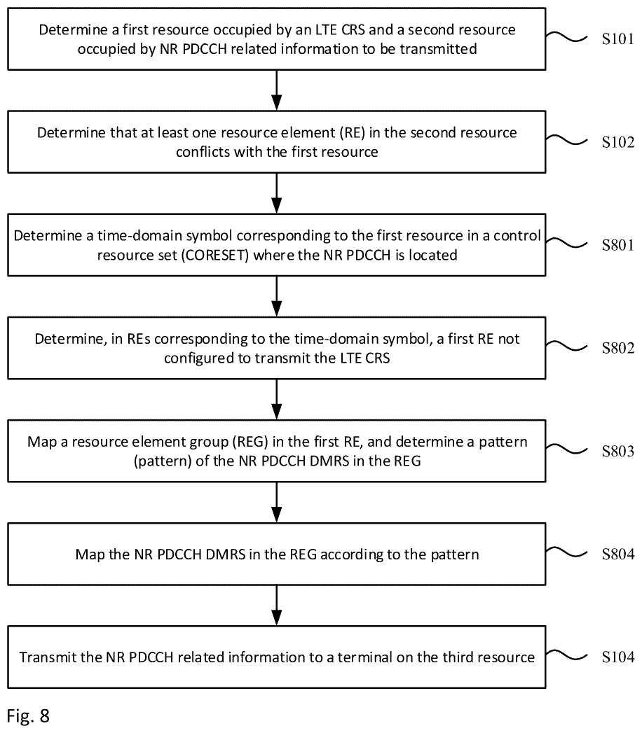

FIG. 8 is a schematic flow diagram of yet another method for transmitting a physical downlink control channel according to an example of the disclosure. As shown in FIG. 8, in a case that the NR PDCCH related information includes the NR PDCCH DMRS, the steps of adjusting the second resource and obtaining a third resource include:

Step 801, a time-domain symbol corresponding to the first resource in a control resource set (CORESET) where the NR PDCCH is located is determined.

Step 802, a first RE not configured to transmit the LTE CRS is determined in REs corresponding to the time-domain symbol.

Step 803, a resource element group (REG) is mapped in the first RE, and a pattern (pattern) of the NR PDCCH DMRS in the REG is determined.

Step 804, the NR PDCCH DMRS is mapped in the REG according to the pattern.

In an example, in a case that the NR PDCCH related information includes the NR PDCCH DMRS, that is, the RE corresponding to the NR PDCCH DMRS conflicts with the RE corresponding to the LTE CRS, the time-domain symbol corresponding to the first resource may be determined in the CORESET where the NR PDCCH is located, and the NR PDCCH DMRS is also in this CORESET. Then, a first RE not configured to transmit the LTE CRS is determined in the REs corresponding to the time-domain symbols. The REG is mapped in the first RE, and a pattern (pattern) of the NR PDCCH DMRS in the REG is determined. Finally, the NR PDCCH DMRS is mapped in the REG according to the pattern.

Since no LTE CRS exists in the first RE, the REG is mapped in the first RE. An RE to which the REG is mapped does not conflict with the RE corresponding to the LTE CRS. Further, the NR PDCCH DMRS is mapped to the REG according to the pattern (pattern) of the NR PDCCH DMRS in the REG. Thus, the RE corresponding to the NR PDCCH DMRS does not conflict with the RE corresponding to the LTE CRS.

Accordingly, on the basis that an RE corresponding to the NR PDCCH DMRS does not conflict with an RE corresponding to the LTE CRS, a number of NR PDCCH DMRSs carried on each REG can be ensured unchanged such that a performance of demodulating the NR PDCCH based on the NR PDCCH DMRS can be ensured.

In an example, the REG structure is a newly defined structure or an existing REG structure.

An REG structure mapped in the first RE may be an existing REG structure. For example, one REG corresponds to one symbol in a time domain and 12 REs in a frequency domain. The REG structure mapped in the first RE may also be a newly defined REG structure. For example, one REG corresponds to one symbol on the time domain and 18 REs on the frequency domain.

In an example, the pattern is a newly defined pattern or an existing pattern.

In the REG mapped to the first RE, the pattern of the NR PDCCH DMRS may be an existing pattern. For example, REs corresponding to the NR PDCCH DMRS in the REG are RE#1, RE#5 and RE#9. The pattern of the NR PDCCH DMRS may also be a defined pattern, which may be specifically set according to requirements.

It should be noted that the REG structure and the pattern of the NR PDCCH DMRS may be determined by the terminal according to an indication of the network-side device, or may be determined based on a protocol.

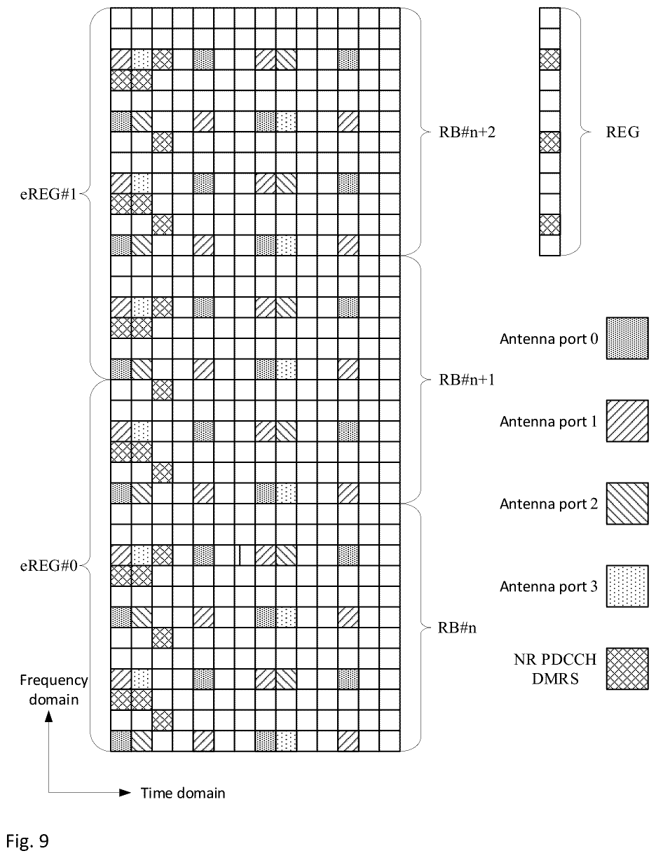

FIG. 9 is a schematic diagram of another third resource according to an example of the disclosure.

For example, the REG structure is a newly defined structure, and specifically corresponds to one symbol in a time domain and 18 REs in a frequency domain. The pattern of the NR PDCCH DMRS is an existing pattern. For example, REs corresponding to the NR PDCCH DMRS in the REG are RE#1, RE#5 and RE#9.

As shown in FIG. 9, cases of CORESETs of 3 RBs (RB#n, RB#n+1 and RB#n+2) are shown. Certainly, the CORESET does not correspond to 3 RBs on the time domain. For example, the CORESET corresponds to fewer or more RBs.

For example, the first resource corresponding to the LTE CR on the first 2 symbols in the RB are RE#0, RE#3, RE#6 and RE#9 in each RB. Based on the example, the first REs on the first 2 symbols, that is, RE#1, RE#2, RE#4, RE#5, RE#7, RE#8, RE#10 and RE#11 in each RB on the first 2 symbols, which are determined to not be configured to transmit the LTE CR, can be determined.

Further, an REG (for example, referred to as an eREG) may be mapped in the determined first RE. For example, an REG corresponds to one symbol on the time domain and 12 REs on the frequency domain. Since 24 first REs exist in a frequency-domain range of 3 RBs in the first 2 symbols, 2 REGs (which are eREG#0 and eREG#1 respectively) may be mapped on the 24 first REs. An existing pattern may still be used as the pattern (pattern) of the NR PDCCH DMRS in the REG. For example, REs corresponding to NR PDCCH DMRS in the REG mapped to the first RE are RE#1, RE#5 and RE#9 (an RE corresponding to the LTE CRS is ignored during RE numbering in the first RE).

In an example, after the step of mapping an REG in the first RE, if remaining REs are insufficient to map a complete REG, the method further includes:
the NR PDCCH DMRS is not mapped in the remaining REs; or
the NR PDCCH DMRS is mapped in the remaining REs according to an existing pattern of the NR PDCCH DMRS in an existing REG structure.

In some cases, a number of the first REs may exactly divide a number of REs in the REG, then the REG may be mapped in the first REs such that an integer number of REGs may be mapped in the first REs. For example, in an example shown in FIG. 9, 12 REs exit in the REG, and 24 first REs exist.

However, in some cases, the number of the first REs cannot exactly divide the number of REs in the REG. For example, 1 RB still exists on the basis of the example shown in FIG. 9, and the pattern of the LTE CRS is the same as those of the other 3 RBs such that 32 first REs exist. In a case that 12 REs exit in the REG, after 2 REGs are mapped on the first RE, remaining 8 first REs are insufficient to map a complete REG.

In this case, the NR PDCCH DMRS may not be mapped in the remaining REs, or the NR PDCCH DMRS may be mapped in the remaining REs according to an existing pattern of the NR PDCCH DMRS in the existing REG structure. For example, the NR PDCCH DMRS is mapped according to RE#1, RE#5 and RE#9. In this case, the REGs are not mapped in the remaining REs, such that the REGs still include the REs corresponding to the LTE CRS. Thus, the LTE CRS exists in RE#9, and the NR PDCCH DMRS may be mapped in RE#1 and RE#5 in the remaining 8 REs.

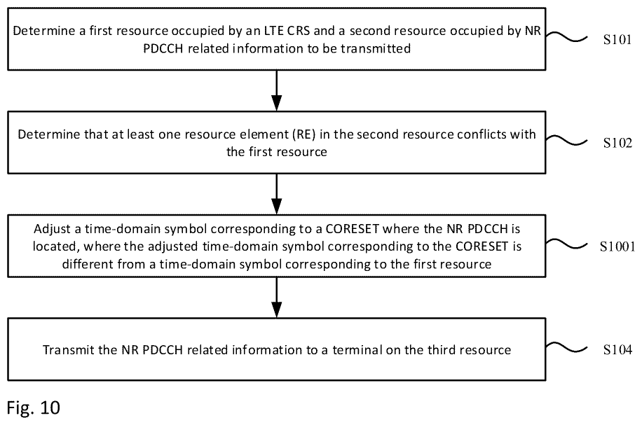

FIG. 10 is a schematic flow diagram of yet another method for transmitting a physical downlink control channel according to an example of the disclosure. As shown in FIG. 10, in a case that the NR PDCCH related information includes the NR PDCCH DMRS, the steps of adjusting the second resource and obtaining a third resource include:

Step 1001, a time-domain symbol corresponding to a CORESET where the NR PDCCH is located is adjusted. The adjusted time-domain symbol corresponding to the CORESET is different from a time-domain symbol corresponding to the first resource.

In an example, the time-domain position of the RE in the second resource that conflicts with the first resource may be changed. For example, the time-domain position is moved backwards on a time domain. A moving distance may be one or more time-domain symbols. A specific method for changing the time-domain position may be determined according to an indication of the network-side device, or may be determined based on a protocol.

Since the adjusted time-domain symbol corresponding to the CORESET is different from the time-domain symbol corresponding to the first resource, on the basis that an RE corresponding to the NR PDCCH DMRS does not conflict with an RE corresponding to the LTE CRS, a number of NR PDCCH DMRSs carried on each REG can be ensured unchanged such that a performance of demodulating the NR PDCCH based on the NR PDCCH DMRS can be ensured.

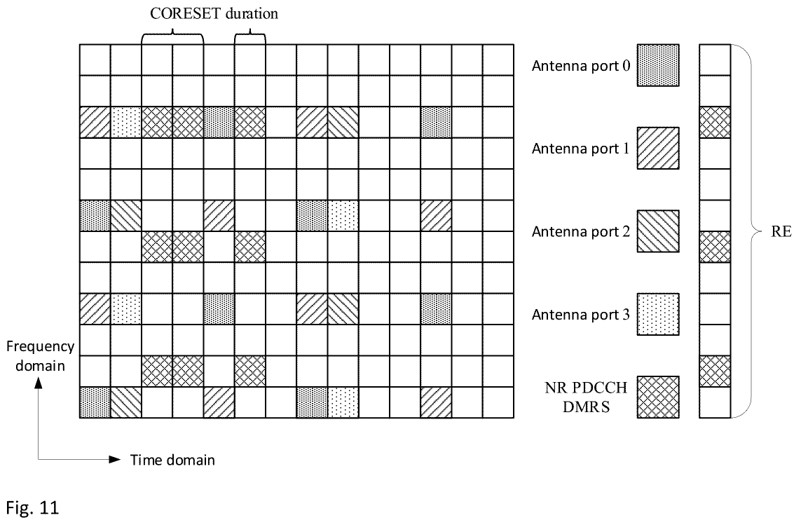

FIG. 11 is a schematic diagram of yet another third resource according to an example of the disclosure.

As shown in FIG. 11, in a case of the first resource shown in FIG. 5, if the CORESET occupies the first 3 symbols in one RB, and REs corresponding to the NR PDCCH DMRS in the REG are RE#1, RE#5 and RE#9, RE#9 on the first symbol and the second symbol conflicts with the first resource such that the first symbol and the second symbol can be adjusted, for example, moved backwards on a time domain.

Since after the 3rd symbol, an RE corresponding to the LTE CRS exists on the 5th symbol, and no RE corresponding to the LTE CRS exists on the 4th symbol and 6th symbol, the time-domain symbols corresponding to the CORESET may be adjusted to the 3rd symbol (as a first time-domain symbol of the CORESET), the 4th symbol (as a second time-domain symbol of the CORESET), and the 6th symbol (as a third time-domain symbol of the CORESET).

In an example, the adjusted time-domain symbols corresponding to the CORESET are continuous time-domain symbols or discrete time-domain symbols.

Based on a difference between the LTE CRS and the CORESET duration, the adjusted time-domain symbols corresponding to the CORESET may be continuous time-domain symbols or discrete time-domain symbols. For example, as shown in FIG. 11, the adjusted time-domain symbols corresponding to the CORESET are discrete time-domain symbols. In a case that the CORESET duration is 2 time-domain symbols, the time-domain symbols corresponding to the CORESET may be adjusted to the 3rd symbol and the 4th symbol, such that the adjusted time-domain symbols corresponding to the CORESET are continuous time-domain symbols.

In an example, the step of adjusting a time-domain symbol corresponding to a CORESET where the NR PDCCH is located includes:
the time-domain symbol corresponding to the CORESET where the NR PDCCH is located is adjusted through a specified method. The network-side device and the terminal pre-store the specified method.

The network-side device may adjust, through a specified method, the time-domain symbol corresponding to the CORESET where the NR PDCCH is located. In this case, the network-side device and the terminal may pre-store the specified method, such that it is ensured that after receiving the PDCCH, the terminal can also determine the adjusted time-domain symbol corresponding to the CORESET through the specified method.

In an example, the method further includes:
the adjusted time-domain symbol corresponding to the CORESET is indicated to

the terminal via a Radio Resource control (RRC) signaling.

In addition to adjusting the time-domain symbol corresponding to the CORESET through a pre-stored specified method, the network-side device may also adjust the time-domain symbol corresponding to the CORESET according to requirements, and may indicate (for example, indicate through codebook bitmap) the adjusted time-domain symbol corresponding to the CORESET to the terminal via an RRC signaling such that the terminal can determine, according to the RRC signaling, how the terminal adjusts the time-domain symbol corresponding to the CORESET, and further determine the adjusted time-domain symbol corresponding to the CORESET.

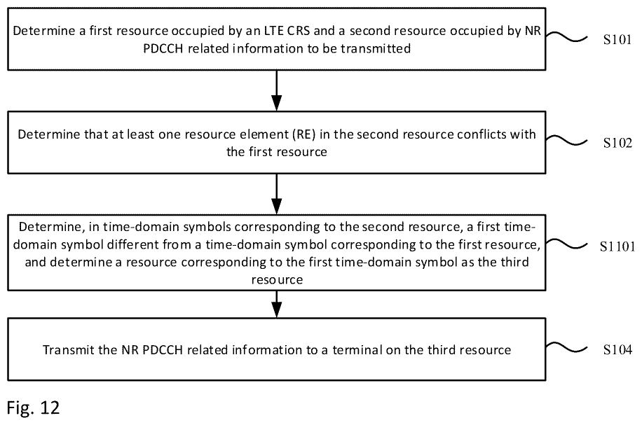

FIG. 12 is a schematic flow diagram of still another method for transmitting a physical downlink control channel according to an example of the disclosure. As shown in FIG. 12, in a case that the NR PDCCH related information includes the NR PDCCH DMRS, the steps of adjusting the second resource and obtaining a third resource include:

Step 1101, a first time-domain symbol different from a time-domain symbol corresponding to the first resource is determined in time-domain symbols corresponding to the second resource, and a resource corresponding to the first time-domain symbol is determined as the third resource.

In an example, the network-side device may determine, in time-domain symbols corresponding to the second resource, a first time-domain symbol different from a time-domain symbol corresponding to the first resource, and further determine that a resource corresponding to the first time-domain symbol as the third resource. That is, the NR PDCCH DMRS is transmitted only on the first time-domain symbol in the second resource that does not conflict with the first resource.

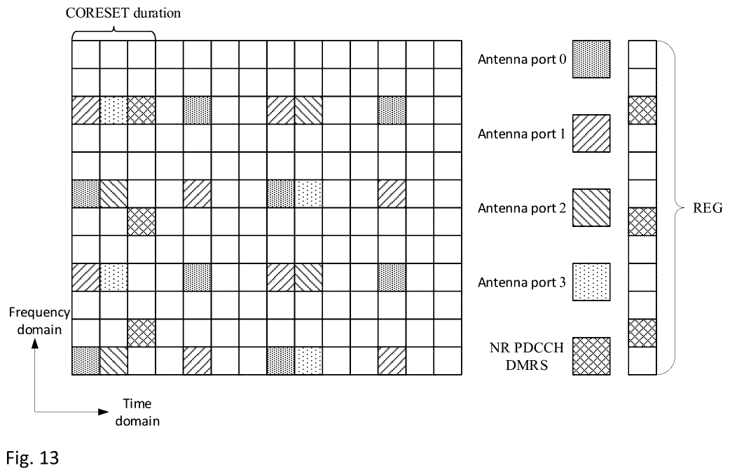

FIG. 13 is a schematic diagram of still another third resource according to an example of the disclosure.

As shown in FIG. 13, on the basis of the first resource and the second resource shown in FIG. 5, NR PDCCH DMRSs exist on the first 3 symbols, LTE CRSs exist on the first 2 symbols, and the second resource conflicts with the first resource on the first 2 symbols. Specifically, RE#9 on the first symbol and the second symbol conflicts with the first resource.

In this case, in the example, it can be determined that the resource corresponding to the third symbol is the third resource (the frequency-domain range may be the frequency-domain range corresponding to the CORESET). Since no LTE CRS exits on the third symbol, no conflict occurs on the LTE CRS if the NR PDCCH DMRS is transmitted on the third symbol. On this basis, the CORESET duration may be set to be unchanged. For example, as shown in FIG. 13, 3 symbols still exist, but no NR PDCCH DMRS is transmitted on the first two symbols, and the NR PDCCH such as the DCI is still transmitted.

Accordingly, on the basis that an RE corresponding to the NR PDCCH DMRS does not conflict with an RE corresponding to the LTE CRS, a number of NR PDCCH DMRSS carried on each REG can be ensured unchanged such that a performance of demodulating the NR PDCCH based on the NR PDCCH DMRS can be ensured.

In an example, at least one first time-domain symbol exists in the time-domain symbols corresponding to the second resource. In order to ensure that the third resource exists, it is required to ensure that at least one first time-domain symbol exists in the time-domain symbols corresponding to the second resource such that it can be determined that the resource corresponding to the first time-domain symbol is the third resource, and then the NR PDCCH DMRS can be transmitted on the third resource.

In an example, the method further includes:
indicating, via a radio resource control signaling, whether the NR PDCCH DMRS is transmitted only on a first time-domain symbol, different from the time-domain symbol corresponding to the first resource, of the time-domain symbols corresponding to the second resource to the terminal; and
determining the resource corresponding to the first time-domain symbol as the third resource in a case that the NR PDCCH DMRS is transmitted only on the first time-domain symbol, different from the time-domain symbol corresponding to the first resource, of the time-domain symbols corresponding to the second resource.

The network-side device may indicate, via an RRC signaling, whether the NR PDCCH DMRS is transmitted only on the first time-domain symbol, different from the time-domain symbol corresponding to the first resource, of the time-domain symbols corresponding to the second resource to the terminal. The network-side device can determine that the resource corresponding to the first time-domain symbol is the third resource in a case that the network-side device indicates that the NR PDCCH DMRS is transmitted only on the first time-domain symbol, different from the time-domain symbol corresponding to the first resource, of the time-domain symbols corresponding to the second resource. In a case that the network-side device does not indicate that the NR PDCCH DMRS is transmitted only on the first time-domain symbol, different from the time-domain symbol corresponding to the first resource, of the time-domain symbols corresponding to the second resource, the third resource may be determined through a method for determining a third resource in the other examples described above.

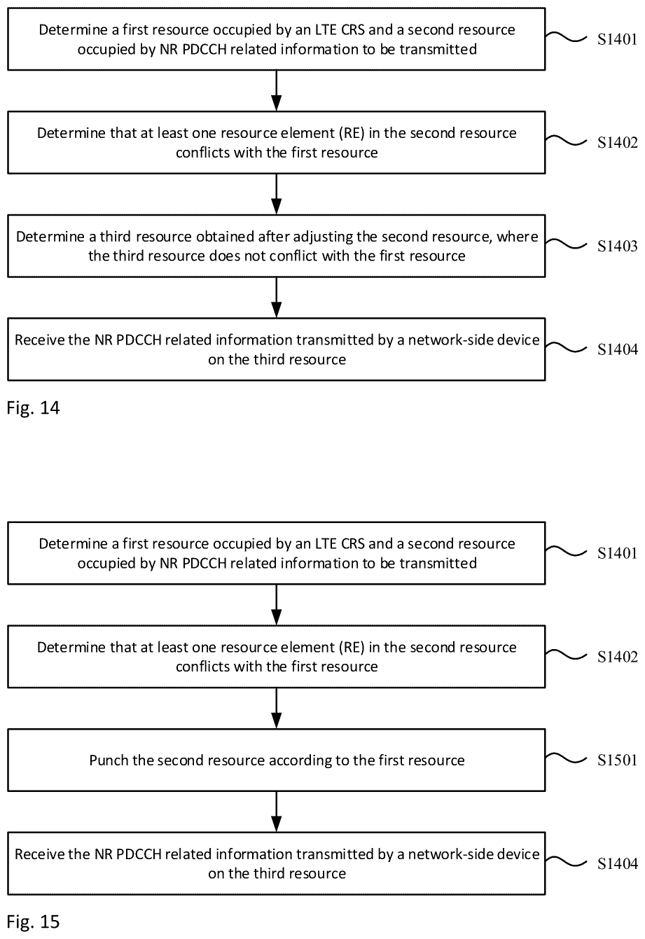

FIG. 14 is a schematic flow diagram of a method for receiving a physical downlink control channel according to an example of the disclosure. The method for receiving a physical downlink control channel shown in the example may be performed by a terminal. The terminal may be in communication with a network-side device. The terminal includes but is not limited to communication apparatuses such as a mobile phone, a tablet computer, a wearable device, a sensor, and an internet of things device. The network-side device includes but is not limited to network-side devices in 4th generation (4G), 5th generation (5G), 6th generation (6G) and other communication systems, such as base stations and core networks. The base station includes but is not limited to base stations in communication systems, such as a 4G base station, a 5G base station and a 6G base station.

As shown in FIG. 14, the method for receiving a physical downlink control channel may include steps as follows:

Step 1401, a first resource occupied by a long term evolution cell-specific reference signal (LTE CRS) and a second resource occupied by new radio physical downlink control channel (NR PDCCH) related information to be transmitted is determined.

Step 1402, at least one resource element (RE) in the second resource that conflicts with the first resource is determined.

Step 1403, a third resource obtained after adjusting the second resource is determined, where the third resource does not conflict with the first resource.

Step1404, the NR PDCCH related information transmitted by a network-side device is received on the third resource.

In the related art, since the first resource occupied by the LTE CRS is determined, it is difficult for the NR network-side device to change the first resource. When it is determined that at least one RE in the second resource occupied by the NR PDCCH related information conflicts with the first resource, for example, at least one RE in the second resource overlaps at least one RE in the first resource, the terminal will not receive the NR PDCCH related information including this overlapping RE. Accordingly, the NR network-side device will not transmit the NR PDCCH related information including this overlapping RE.

In an example, the NR PDCCH related information includes at least one of:
an NR PDCCH demodulation reference signal (DMRS) of an NR PDCCH; or
downlink control information (DCI) carried by the NR PDCCH.

In a case that the NR PDCCH related information includes the DCI, the terminal in the related art does not expect to receive a PDCCH candidate including this overlapping RE. Accordingly, the NR network-side device does not transmit the PDCCH candidate including this overlapping RE.

Since the PDCCH candidate does not only include individual REs, but includes at least one control channel element (CCE). One CCE includes a large number of REs. The NR network-side device does not transmit the PDCCH candidate including this overlapping RE, It is indicated that if a PDCCH candidate that the NR network-side device originally is required to transmit includes this overlapping RE, the entire PDCCH candidate is not transmitted. As a result, no DCI is transmitted on all CCEs (in which an RE that does not conflict with the first resource may exist) included in the PDCCH candidate. Thus, a large number of REs (such as REs that do not conflict with the first resource) are not used, and a transmission performance and scheduling flexibility of the NR PDCCH are severely restricted.

According to examples of the disclosure, when it is determined that at least one resource element (RE) in the second resource conflicts with the first resource, the network-side device does not directly give up transmitting the NR PDCCH related information including the conflicting RE, but can adjust the second resource and obtain the third resource. Accordingly, a terminal may determine a third resource obtained after the second resource is adjusted, and further receive the NR PDCCH related information transmitted by the network-side device on the third resource. Since the obtained third resource does not conflict with the first resource, in a case of ensuring that an RE in a resource corresponding to the NR PDCCH related information does not conflict with the first resource, an impact of the LTE CRS on the NR PDCCH related information is reduced, and a large number of REs that do not conflict with the first resource are prevented from being discarded such that a transmission performance and scheduling flexibility can be improved.

It should be noted that a method through which the network-side device adjusts the second resource and obtains the third resource may be indicated to the terminal by the network-side device. For example, the method may be indicated to the terminal via system information, paging signaling, etc. Alternatively, the method may be determined based on a protocol. For example, the terminal may also determine, based on a protocol, the method through which the network-side device adjusts the second resource and obtains the third resource.

For example, in a case that at least one resource element (RE) in the second resource conflicts with the first resource, a terminal may determine a third resource obtained after the second resource is adjusted, and further receive the NR PDCCH related information on the third resource transmitted by the network-side device. The terminal may determine, according to an indication of the network-side device or according to a protocol, how to adjust the second resource and obtain the third resource.

With respect to the NR PDCCH related information, the NR PDCCH DMRS and the DCI are mainly taken as examples in examples of the disclosure. During practical application, examples of the disclosure may also be applied to other NR PDCCH related information according to requirements. A case that the NR PDCCH related information includes the DCI will be illustratively described below through several examples.

FIG. 15 is a schematic flow diagram of another method for receiving a physical downlink control channel according to an example of the disclosure. As shown in FIG. 15, in a case that the NR PDCCH related information includes the DCI, the step of determining a third resource obtained after the second resource is adjusted includes:

Step 1501, the second resource is punched according to the first resource.

In an example, the network-side device may punch the second resource according to the first resource, for example, remove a RE that conflicts with the first resource from the second resource through punching, the remaining resources may serve as the third resources. That is, for the network-side device, the DCI is transmitted on an RE in the second resource that does not conflict with the first resource, this operation process is relatively simple and easy to implement.

Since the network-side device executes a transmitting operation, and the terminal executes a receiving operation, in a case that the network-side device punches the second resource according to the first resource, a specific operation of punching the second resource by the terminal according to the first resource may be different from a specific operation by the network-side device. For example, a case that the terminal punches the second resource according to the first resource means that the terminal still receives the DCI on the second resource regardless of existence of the LTE CRS when receiving the DCI.

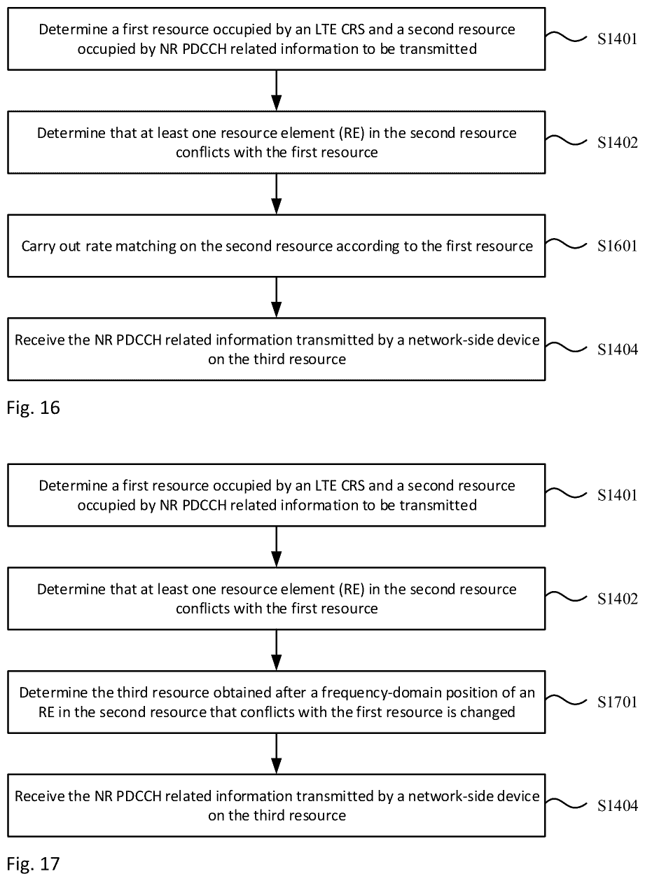

FIG. 16 is a schematic flow diagram of yet another method for receiving a physical downlink control channel according to an example of the disclosure. As shown in FIG. 16, in a case that the NR PDCCH related information includes the DCI, the step of determining a third resource obtained after the second resource is adjusted includes:

Step1601, rate matching is carried out on the second resource according to the first resource.

In an example, the network-side device may carry out rate matching on the second resource according to the first resource, for example, determine an RE in the second resource that does not conflict with the first resource as the third resource, and then transmit the DCI on the third resource. Correspondingly, the terminal may carry out the rate matching on the second resource according to the first resource, determine an RE in the second resource that does not conflict with the first resource as the third resource, and then receive the DCI on the third resource.

A case that the NR PDCCH related information includes the NR PDCCH DMRS will be illustratively described below through several examples.

It should be noted that the DCI in the above example is information carried by the NR PDCCH, while the NR PDCCH DMRS is not information carried by the NR PDCCH but is information configured to demodulate the NR PDCCH. However, in some cases, the NR PDCCH DMRS may also be set in the control resource set (CORESET) where the NR PDCCH is located, so as to be transmitted. Thus, the RE corresponding to the NR PDCCH DMRS and the RE corresponding to the DCI may both conflict with the first resource.

When the DCI is transmitted, even if the RE corresponding to the DCI conflicts with the first resource, the DCI may be transmitted through punching or rate matching. However, when the RE corresponding to the NR PDCCH DMRS conflicts with the first resource, the NR PDCCH DMRS cannot be transmitted through punching or rate matching, and other methods are required to be considered to determine the third resource.

FIG. 17 is a schematic flow diagram of yet another method for receiving a physical downlink control channel according to an example of the disclosure. As shown in FIG. 17, in a case that the NR PDCCH related information includes the NR PDCCH DMRS, the step of the determining a third resource obtained after the second resource is adjusted includes:

Step 1701, the third resource obtained after changing a frequency-domain position (specifically, a frequency-domain position where the conflicting RE carries the NR PDCCH DMRS) of the RE in the second resource that conflicts with the first resource is determined.

In an example, the terminal may determine how the network-side device changes the frequency-domain position of the RE in the second resource that conflicts with the first resource, for example, move the frequency-domain position of the RE in the second resource that conflicts with the first resource to a high frequency or a low frequency. A moving distance may be one or more REs. A specific method for changing the frequency-domain position may be determined according to an indication of the network-side device, or may be determined based on a protocol. Further, the terminal may determine the third resource obtained after a frequency-domain position of an RE in the second resource that conflicts with the first resource is changed.

Accordingly, on the basis that an RE corresponding to the NR PDCCH DMRS does not conflict with an RE corresponding to the LTE CRS, a number of NR PDCCH DMRSs carried on each REG can be ensured unchanged such that a performance of demodulating the NR PDCCH based on the NR PDCCH DMRS can be ensured.

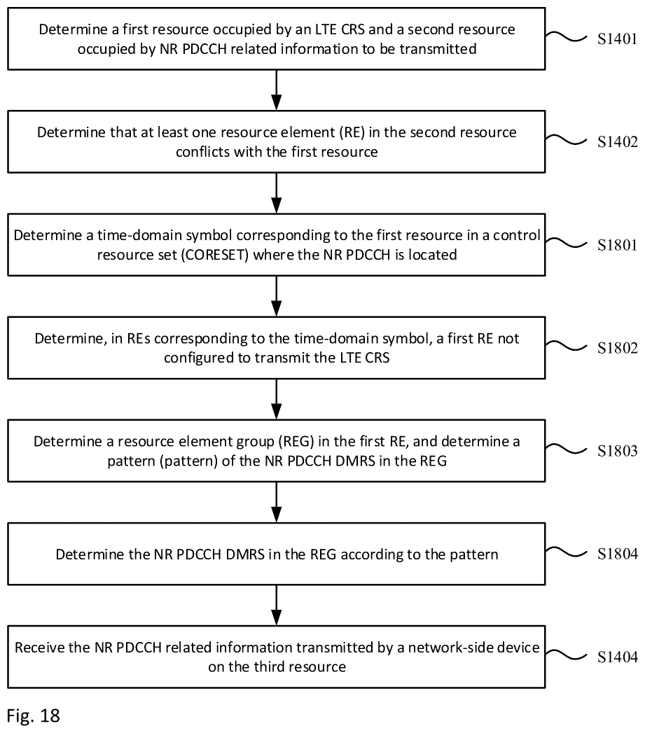

FIG. 18 is a schematic flow diagram of yet another method for receiving a physical downlink control channel according to an example of the disclosure. As shown in FIG. 18, in a case that the NR PDCCH related information includes the NR PDCCH DMRS, the step of the determining a third resource obtained after the second resource is adjusted includes:

Step 1801, a time-domain symbol corresponding to the first resource is determined in a control resource set (CORESET) where the NR PDCCH is located.

Step1802, a first RE not configured to transmit the LTE CRS is determined in REs corresponding to the time-domain symbol.

Step1803, a resource element group (REG) is mapped in the first RE, and a pattern (pattern) of the NR PDCCH DMRS in the REG is determine.

Step1804, the NR PDCCH DMRS is mapped in the REG according to the pattern.

In an example, in a case that the NR PDCCH related information includes the NR PDCCH DMRS, that is, the RE corresponding to the NR PDCCH DMRS conflicts with the RE corresponding to the LTE CRS, the time-domain symbol corresponding to the first resource may be determined in the CORESET where the NR PDCCH is located, and the NR PDCCH DMRS is also in this CORESET. Then, a first RE not configured to transmit the LTE CRS is determined in the REs corresponding to the time-domain symbols. The REG is determined in the first RE, and a pattern (pattern) of the NR PDCCH DMRS in the REG is determined. Finally, the NR PDCCH DMRS is determined in the REG according to the pattern.

Since no LTE CRS exits in the first RE, the mapped REG is determined in the first RE. An RE to which the REG is mapped does not conflict with the RE corresponding to the LTE CRS. Further, the NR PDCCH DMRS is mapped to the REG according to the pattern (pattern) of the NR PDCCH DMRS in the REG. Thus, the RE corresponding to the NR PDCCH DMRS does not conflict with the RE corresponding to the LTE CRS. Thus, the RE corresponding to the NR PDCCH DMRS mapped in the REG according to the pattern by the terminal does not conflict with the RE corresponding to the LTE CRS.

Accordingly, on the basis that an RE corresponding to the NR PDCCH DMRS does not conflict with an RE corresponding to the LTE CRS, a number of NR PDCCH DMRSs carried on each REG can be ensured unchanged such that a performance of demodulating the NR PDCCH based on the NR PDCCH DMRS can be ensured.

In an example, the REG structure is a newly defined structure or an existing REG structure.

An REG structure mapped in the first RE may be an existing REG structure. For example, one REG corresponds to one symbol in a time domain and 12 REs in a frequency domain. The REG structure mapped in the first RE may also be a newly defined REG structure. For example, one REG corresponds to one symbol on the time domain and 18 REs on the frequency domain.

In an example, the pattern is a newly defined pattern or an existing pattern.

In the REG mapped to the first RE, the pattern of the NR PDCCH DMRS may be an existing pattern. For example, REs corresponding to the NR PDCCH DMRS in the REG are RE#1, RE#5 and RE#9. The pattern of the NR PDCCH DMRS may also be a defined pattern, which may be specifically set according to requirements.

It should be noted that the REG structure and the pattern of the NR PDCCH DMRS may be determined by the terminal according to an indication of the network-side device, or may be determined based on a protocol.

In an example, after the step of mapping an REG in the first RE, if remaining REs are insufficient to map a complete REG, the method further includes:
not expecting to receive the NR PDCCH DMRS in the remaining REs; or
receiving the NR PDCCH DMRS in the remaining REs according to an existing pattern of the NR PDCCH DMRS in an existing REG structure.

In some cases, a number of the first REs may exactly divide a number of REs in the REG, then the REG may be mapped in the first REs such that an integer number of REGs may be mapped in the first REs. For example, in an example shown in FIG. 9, 12 REs exit in the REG, and 24 first REs exist.

However, in some cases, the number of the first REs cannot exactly divide the number of REs in the REG. For example, 1 RB still exists on the basis of the example shown in FIG. 9, and the pattern of the LTE CRS is the same as those of the other 3 RBs such that 32 first REs exist. In a case that 12 REs exit in the REG, after 2 REGs are mapped on the first RE, remaining 8 first REs are insufficient to map a complete REG.

In this case, the terminal may not be expected to receive the NR PDCCH DMRS in the remaining REs, or the NR PDCCH DMRS may be determined in the remaining REs according to an existing pattern of the NR PDCCH DMRS in the existing REG structure. For example, the NR PDCCH DMRS is received according to RE#1, RE#5 and RE#9. In this case, the REGs are not mapped in the remaining REs, such that the REGs still include the REs corresponding to the LTE CRS. Thus, the LTE CRS exists in RE#9, and the NR PDCCH DMRS may be mapped only on RE#1 and RE#5 in the remaining 8 REs. Thus, in the remaining 8 REs, the NR PDCCH DMRSs are determined only on RE#1 and RE#5.

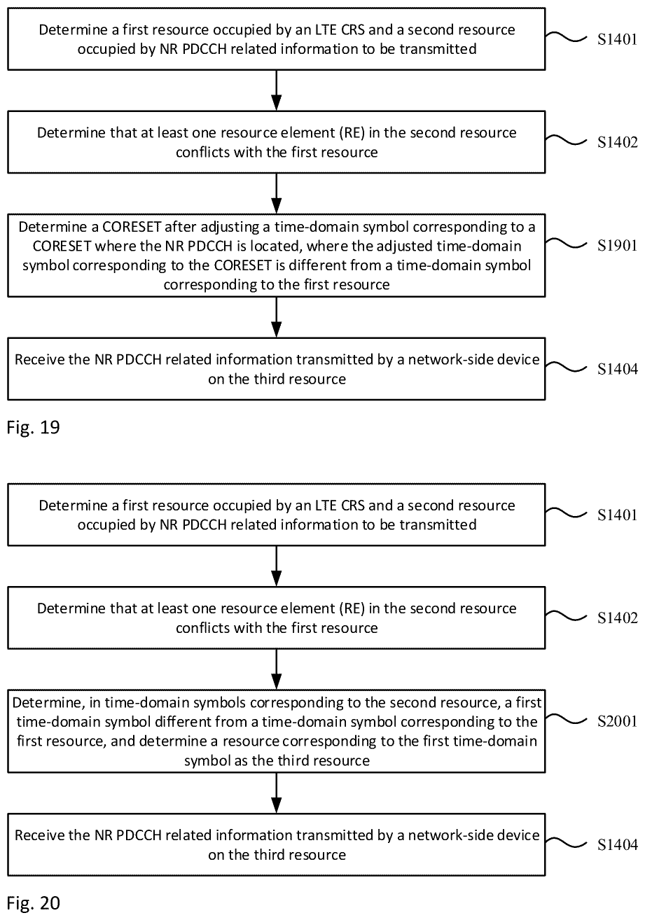

FIG. 19 is a schematic flow diagram of yet another method for receiving a physical downlink control channel according to an example of the disclosure. As shown in FIG. 19, in a case that the NR PDCCH related information includes the NR PDCCH DMRS, the step of the determining a third resource obtained after the second resource is adjusted includes:

Step 1901, a CORESET after adjusting a time-domain symbol corresponding to a CORESET where the NR PDCCH is located is determined. The adjusted time-domain symbol corresponding to the CORESET is different from a time-domain symbol corresponding to the first resource.

In an example, the time-domain position of the RE in the second resource that conflicts with the first resource may be changed by the network-side device. For example, the time-domain position is moved backwards on a time domain. A moving distance may be one or more time-domain symbols. A specific method for changing the time-domain position may be determined according to an indication of the network-side device, or may be determined based on a protocol. The terminal may determine a CORESET after a time-domain symbol corresponding to a CORESET where the NR PDCCH is located is adjusted. The adjusted time-domain symbol corresponding to the CORESET is different from a time-domain symbol corresponding to the first resource. The adjusted CORESET can serve as a third resource.

Since the adjusted time-domain symbol corresponding to the CORESET is different from the time-domain symbol corresponding to the first resource, on the basis that an RE corresponding to the NR PDCCH DMRS does not conflict with an RE corresponding to the LTE CRS, a number of NR PDCCH DMRSs carried on each REG can be ensured unchanged such that a performance of demodulating the NR PDCCH based on the NR PDCCH DMRS can be ensured.

In an example, the adjusted time-domain symbols corresponding to the CORESET are continuous time-domain symbols or discrete time-domain symbols.

Based on a difference between the LTE CRS and the CORESET duration, the adjusted time-domain symbols corresponding to the CORESET may be continuous time-domain symbols or discrete time-domain symbols. For example, as shown in FIG. 11, the adjusted time-domain symbols corresponding to the CORESET are discrete time-domain symbols. In a case that the CORESET duration is 2 time-domain symbols, the time-domain symbols corresponding to the CORESET may be adjusted to the 3rd symbol and the 4th symbol, such that the adjusted time-domain symbols corresponding to the CORESET are continuous time-domain symbols.

In an example, the step of determining a CORESET after a time-domain symbol corresponding to a CORESET where the NR PDCCH is located is adjusted includes:
the CORESET after adjusting the time-domain symbol corresponding to the CORESET where the NR PDCCH is located is adjusted is determined through a specified method. The network-side device and the terminal pre-store the specified method.

The network-side device may adjust, through a specified method, the time-domain symbol corresponding to the CORESET where the NR PDCCH is located. The terminal may determine the CORESET after the time-domain symbol corresponding to the CORESET where the NR PDCCH is located is adjusted through the specified method. In this case, the network-side device and the terminal may pre-store the specified method, such that it is ensured that after receiving the PDCCH, the terminal can also determine the adjusted time-domain symbol corresponding to the CORESET through the specified method.

In an example, the method further includes:
indicating, via a radio resource control signaling, the adjusted time-domain symbol corresponding to the CORESET to the terminal.

The adjusted time-domain symbol corresponding to the CORESET is indicated to the terminal via the radio resource control signaling.

In addition to adjusting the time-domain symbol corresponding to the CORESET through a pre-stored specified method, the network-side device may also adjust the time-domain symbol corresponding to the CORESET according to requirements, and may indicate (for example, indicate through codebook bitmap) the adjusted time-domain symbol corresponding to the CORESET to the terminal via an RRC signaling such that the terminal can determine, according to the RRC signaling, how the terminal adjusts the time-domain symbol corresponding to the CORESET, and further determine the adjusted time-domain symbol corresponding to the CORESET.

FIG. 20 is a schematic flow diagram of still another method for receiving a physical downlink control channel according to an example of the disclosure. As shown in FIG. 20, in a case that the NR PDCCH related information includes the NR PDCCH DMRS, the step of the determining a third resource obtained after the second resource is adjusted includes:

Step 2001, a first time-domain symbol different from a time-domain symbol corresponding to the first resource is determined in time-domain symbols corresponding to the second resource, and a resource corresponding to the first time-domain symbol is determined as the third resource.

In an example, the network-side device may determine, in time-domain symbols corresponding to the second resource, a first time-domain symbol different from a time-domain symbol corresponding to the first resource, and further determine that a resource corresponding to the first time-domain symbol as the third resource. That is, the NR PDCCH DMRS is transmitted only on the first time-domain symbol in the second resource that does not conflict with the first resource.

Accordingly, on the basis that an RE corresponding to the NR PDCCH DMRS does not conflict with an RE corresponding to the LTE CRS, a number of NR PDCCH DMRSs carried on each REG can be ensured unchanged such that a performance of demodulating the NR PDCCH based on the NR PDCCH DMRS can be ensured.

In an example, at least one first time-domain symbol exists in the time-domain symbols corresponding to the second resource. In order to ensure that the third resource exists, it is required to ensure that at least one first time-domain symbol exists in the time-domain symbols corresponding to the second resource such that it can be determined that the resource corresponding to the first time-domain symbol is the third resource, and then the NR PDCCH DMRS can be transmitted on the third resource.

In an example, the method further includes:
determining, according to a radio resource control signaling transmitted by a network-side device, whether the NR PDCCH DMRS is transmitted only on the first time-domain symbol, different from the time-domain symbol corresponding to the first resource, of the time-domain symbols corresponding to the second resource; and
determining the resource corresponding to the first time-domain symbol as the third resource in a case that the NR PDCCH DMRS is transmitted only on the first time-domain symbol, different from the time-domain symbol corresponding to the first resource, of the time-domain symbols corresponding to the second resource.

The terminal may determine, according to an RRC signaling transmitted by the network-side device, whether the NR PDCCH DMRS is transmitted only on the first time-domain symbol, different from the time-domain symbol corresponding to the first resource, of the time-domain symbols corresponding to the second resource. In a case that it is determined that the NR PDCCH DMRS is transmitted only on the first time-domain symbol, different from the time-domain symbol corresponding to the first resource, of the time-domain symbols corresponding to the second resource, it can be determined that the resource corresponding to the first time-domain symbol is the third resource. In a case that it is determined that the NR PDCCH DMRS is transmitted not only on the first time-domain symbol, different from the time-domain symbol corresponding to the first resource, of the time-domain symbols corresponding to the second resource, the third resource may be determined through a method for determining the third resource in the other examples described above.

The disclosure further provides examples of an apparatus for transmitting a physical downlink control channel and an apparatus for receiving a physical downlink control channel that correspond to the method for transmitting a physical downlink control channel and a method for receiving a physical downlink control channel mentioned above.

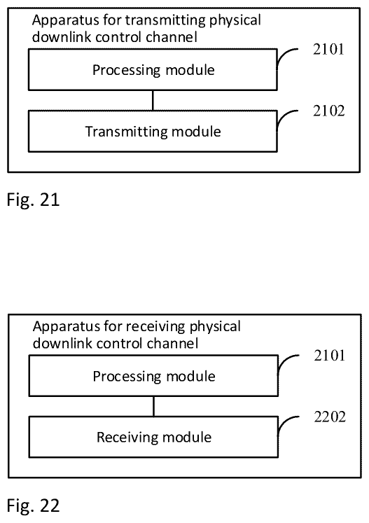

FIG. 21 is a schematic block diagram of an apparatus for transmitting a physical downlink control channel according to an example of the disclosure. The apparatus for transmitting a physical downlink control channel shown in the example may be suitable for a network-side device. The network-side device may be in communication with a terminal. The terminal includes but is not limited to communication apparatuses such as a mobile phone, a tablet computer, a wearable device, a sensor and an internet of things device. The network-side device includes but is not limited to network-side devices in 4G, 5G, 6G and other communication systems, such as base stations and core networks.

As shown in FIG. 21, the apparatus for transmitting a physical downlink control channel may include:
a processing module 2101 configured to determine a first resource occupied by a long term evolution cell-specific reference signal (LTE CRS) and a second resource occupied by new radio physical downlink control channel (NR PDCCH) related information to be transmitted; determine that at least one resource element (RE) in the second resource conflicts with the first resource; and adjust the second resource and obtain a third resource, where the third resource does not conflict with the first resource; and
a transmitting module 2102 configured to transmit the NR PDCCH related information to a terminal on the third resource.

In an example, the NR PDCCH related information includes at least one of:
an NR PDCCH demodulation reference signal (DMRS) of an NR PDCCH; or
downlink control information (DCI) carried by the NR PDCCH.

In an example, in a case that the NR PDCCH related information includes the DCI, the processing module 2101 is configured to punch the second resource according to the first resource.

In an example, in a case that the NR PDCCH related information includes the DCI, the processing module 2101 is configured to carry out rate matching on the second resource according to the first resource.

In an example, in a case that the NR PDCCH related information includes the NR PDCCH DMRS, the processing module 2101 is configured to change a frequency-domain position of an RE in the second resource that conflicts with the first resource and obtain the third resource.

In an example, in a case that the NR PDCCH related information includes the NR PDCCH DMRS, the processing module 2101 is configured to determine a time-domain symbol corresponding to the first resource in a control resource set (CORESET) where the NR PDCCH is located;
determine, in REs corresponding to the time-domain symbol, a first RE not configured to transmit the LTE CRS;
map a resource element group (REG) in the first RE, and determine a pattern (pattern) of the NR PDCCH DMRS in the REG; and
map the NR PDCCH DMRS in the REG according to the pattern.

In an example, the REG structure is a newly defined structure or an existing REG structure.

In an example, the pattern is a newly defined pattern or an existing pattern.

In an example, after the step of mapping an REG in the first RE, if remaining REs are insufficient to map the complete REG, the processing module 2101 is further configured to not map the NR PDCCH DMRS in the remaining REs; or map the NR PDCCH DMRS in the remaining REs according to an existing pattern of the NR PDCCH DMRS in an existing REG structure.

In an example, in a case that the NR PDCCH related information includes the NR PDCCH DMRS, the processing module 2101 is configured to adjust a time-domain symbol corresponding to the CORESET where the NR PDCCH is located. The adjusted time-domain symbol corresponding to the CORESET is different from the time-domain symbol corresponding to the first resource.

In an example, the adjusted time-domain symbols corresponding to the CORESET are continuous time-domain symbols or discrete time-domain symbols.

In an example, the processing module 2101 is configured to adjust, through a specified method, the time-domain symbol corresponding to the CORESET where the NR PDCCH is located. The network-side device and the terminal pre-store the specified method.

In an example, the transmitting module 2102 is further configured to indicate the adjusted time-domain symbol corresponding to the CORESET to the terminal via a radio resource control signaling.

In an example, in a case that the NR PDCCH related information includes the NR PDCCH DMRS, the processing module 2101 is configured to determine, in time-domain symbols corresponding to the second resource, a first time-domain symbol different from a time-domain symbol corresponding to the first resource, and determine a resource corresponding to the first time-domain symbol as the third resource.

In an example, at least one first time-domain symbol exists in the time-domain symbols corresponding to the second resource.

In an example, the transmitting module 2102 is further configured to indicate, via a radio resource control signaling, whether the NR PDCCH DMRS is transmitted to the terminal only on the first time-domain symbol, different from the time-domain symbol corresponding to the first resource, of the time-domain symbols corresponding to the second resource; and
determine the resource corresponding to the first time-domain symbol as the third resource in a case that the NR PDCCH DMRS is transmitted only on the first time-domain symbol, different from the time-domain symbol corresponding to the first resource, of the time-domain symbols corresponding to the second resource.

FIG. 22 is a schematic block diagram of an apparatus for receiving a physical downlink control channel according to an example of the disclosure. The apparatus for receiving a physical downlink control channel shown in the example may be suitable for a terminal. The terminal may be in communication with a network-side device. The terminal includes but is not limited to communication apparatuses such as a mobile phone, a tablet computer, a wearable device, a sensor, and an internet of things device. The network-side device includes but is not limited to network-side devices in 4th generation (4G), 5th generation (5G), 6th generation (6G) and other communication systems, such as base stations and core networks. The base station includes but is not limited to base stations in communication systems, such as a 4G base station, a 5G base station and a 6G base station.

As shown in FIG. 22, the apparatus for receiving a physical downlink control channel may include:
a processing module 2201 configured to determine a first resource occupied by a long term evolution cell-specific reference signal (LTE CRS) and a second resource occupied by new radio physical downlink control channel (NR PDCCH) related information to be transmitted; determine that at least one resource element (RE) in the second resource conflicts with the first resource; and determine a third resource obtained after the second resource is adjusted, where the third resource does not conflict with the first resource; and
a receiving module 2202 configured to receive the NR PDCCH related information transmitted by a network-side device on the third resource.

In an example, the NR PDCCH related information includes at least one of:
an NR PDCCH demodulation reference signal (DMRS) of an NR PDCCH; and
downlink control information (DCI) carried by the NR PDCCH.

In an example, in a case that the NR PDCCH related information includes the DCI, the processing module 2201 is configured to punch the second resource according to the first resource.

In an example, in a case that the NR PDCCH related information includes the DCI, the processing module 2201 is configured to carry out rate matching on the second resource according to the first resource.

In an example, in a case that the NR PDCCH related information includes the NR PDCCH DMRS, the processing module 2201 is configured to determine the third resource obtained after a frequency-domain position of an RE in the second resource that conflicts with the first resource is changed.

In an example, in a case that the NR PDCCH related information includes the NR PDCCH DMRS, the processing module 2201 is configured to determine a time-domain symbol corresponding to the first resource in a control resource set (CORESET) where the NR PDCCH is located;
determine, in REs corresponding to the time-domain symbol, a first RE not configured to transmit the LTE CRS;
map a resource element group (REG) in the first RE, and determine a pattern (pattern) of the NR PDCCH DMRS in the REG; and
map the NR PDCCH DMRS in the REG according to the pattern.

In an example, the REG structure is a newly defined structure or an existing REG structure.

In an example, the pattern is a newly defined pattern or an existing pattern.

In an example, after the step of mapping an REG in the first RE, if remaining REs are insufficient to map the complete REG, the receiving module 2202 is further configured to not expect to receive the NR PDCCH DMRS in the remaining REs; or receive the NR PDCCH DMRS in the remaining REs according to an existing pattern of the NR PDCCH DMRS in an existing REG structure.

In an example, in a case that the NR PDCCH related information includes the NR PDCCH DMRS, the processing module 2201 is configured to determine a CORESET after adjusting a time-domain symbol corresponding to the CORESET where the NR PDCCH is located. The adjusted time-domain symbol corresponding to the CORESET is different from the time-domain symbol corresponding to the first resource.

In an example, the adjusted time-domain symbols corresponding to the CORESET are continuous time-domain symbols or discrete time-domain symbols.

In an example, the processing module 2201 is configured to determine a CORESET after adjusting the time-domain symbol corresponding to the CORESET where the NR PDCCH is located through a specified method. The network-side device and the terminal pre-store the specified method.

In an example, the processing module 2201 is further configured to determine, according to a radio resource control signaling transmitted by the network-side device, the adjusted time-domain symbol corresponding to the CORESET.

In an example, in a case that the NR PDCCH related information includes the NR PDCCH DMRS, the processing module 2201 is configured to determine, in time-domain symbols corresponding to the second resource, a first time-domain symbol different from a time-domain symbol corresponding to the first resource, and determine a resource corresponding to the first time-domain symbol as the third resource.

In an example, at least one first time-domain symbol exists in the time-domain symbols corresponding to the second resource.

In an example, the processing module 2201 is configured to determine, according to a radio resource control signaling transmitted by a network-side device, whether the NR PDCCH DMRS is transmitted only on the first time-domain symbol, different from the time-domain symbol corresponding to the first resource, of the time-domain symbols corresponding to the second resource; and
determine the resource corresponding to the first time-domain symbol as the third resource in a case that the NR PDCCH DMRS is transmitted only on the first time-domain symbol, different from the time-domain symbol corresponding to the first resource, of the time-domain symbols corresponding to the second resource.

A specific method for executing an operation by each module of the apparatus in the above example is described in detail in the example of the related method, and will not be described in detail here.

Since the apparatus example substantially corresponds to the method example, the related parts can be obtained with reference to part of the description of the method example. The apparatus example described above is merely schematic, modules described as separate components can be physically separated or not, and components displayed as modules can be physical units or not. That is, the components can be located at one place, or distributed at a plurality of network modules. Some or all of modules can be selected according to actual requirements to achieve the objective of the solution of the example. Those of ordinary skill in the art can understand and implement the disclosure without making creative efforts.

An example of the disclosure further provides a communication apparatus. The communication apparatus includes one or more processors; and a memory configured to store a computer program. The one or more processors are collectively configured to execute the computer program, so as to perform the method for transmitting a physical downlink control channel mentioned in any one of the above examples.

An example of the disclosure further provides a communication apparatus. The communication apparatus includes one or more processors; and a memory configured to store a computer program. The one or more processors are collectively configured to execute the computer program, so as to perform implements the method for receiving a physical downlink control channel mentioned in any one of the above examples.

An example of the disclosure further provides a non-transitory computer-readable storage medium. The computer-readable storage medium is configured to store a computer program. One or more processors are collectively configured to execute the computer program, so as to perform steps of the method for transmitting a physical downlink control channel mentioned in any one of the above examples.

An example of the disclosure further provides a non-transitory computer-readable storage medium. The computer-readable storage medium is configured to store a computer program. One or more processors are collectively configured to execute the computer program, so as to perform steps of the method for receiving a physical downlink control channel mentioned in any one of the above examples.

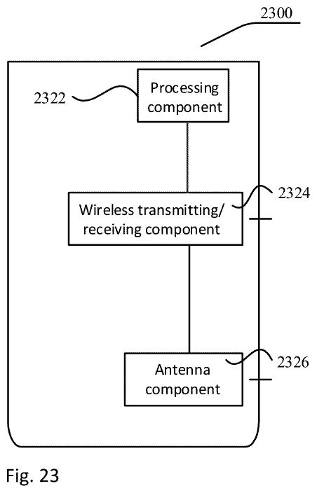

As shown in FIG. 23, a schematic block diagram of an apparatus 2300 for transmitting a physical downlink control channel according to an example of the disclosure is shown in FIG. 23. The apparatus 2300 may be provided as a base station. With reference to FIG. 23, the apparatus 2300 includes a processing component 2322, a wireless transmitting/receiving component 2324, an antenna component 2326, and a signal processing portion specific to a wireless interface. The processing component 2322 may further include one or more processors. one or more processors of the processing component 2322 may be collectively configured to implement the method for transmitting a physical downlink control channel mentioned in any one of the above examples.

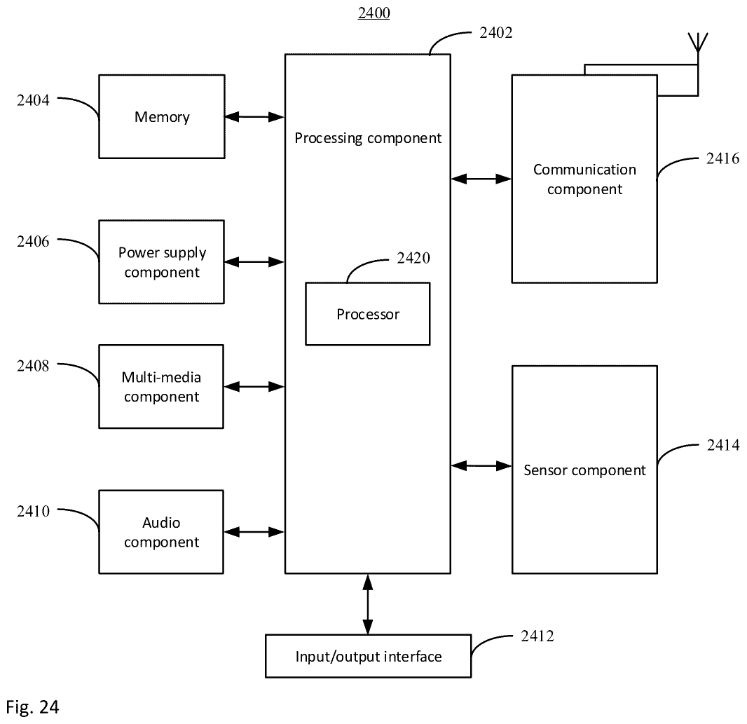

FIG. 24 is a schematic block diagram of an apparatus 2400 for receiving a physical downlink control channel according to an example of the disclosure. For example, the apparatus 2400 may be a mobile phone, a computer, a digital broadcasting terminal, a message receiving and transmitting device, a game console, a tablet device, a medical device, a fitness device, a personal digital assistant, etc.

With reference to FIG. 24, the apparatus 2400 may include one or more of components as follows: a processing component 2402, a memory 2404, a power supply component 2406, a multi-media component 2408, an audio component 2410, an input/output (I/O) interface 2412, a sensor component 2414 and a communication component 2416.

The processing component 2402 generally controls overall operations of the apparatus 2400, such as operations associated with display, telephone call, data communication, camera operations and recording operations. The processing component 2402 may include one or more processors 2420 to execute an instruction, so as to complete all or some steps of the above method for receiving a physical downlink control channel. In addition, the processing component 2402 may include one or more modules such that the processing component 2402 can interact with other components. For example, the processing component 2402 may include a multi-media module such that the multi-media component 2408 can interact with the processing component 2402.

The memory 2404 is configured to store various types of data to support operations at the apparatus 2400. Examples of such data include instructions configured for any application or method operating on the apparatus 2400, such as contact data, phonebook data, messages, pictures and video. The memory 2404 may be implemented by any type of volatile or non-volatile storage devices or their combinations, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 2406 provides power for various components of the apparatus 2400. The power supply component 2406 may include a power supply management system, one or more power supplies, and other components associated with generation, management and power distribution of the apparatus 2400.

The multi-media component 2408 includes a screen that provides an output interface between the apparatus 2400 and a user. In some examples, the screen may include a liquid crystal display (LCD) and a touch panel (TP). If the screen includes a touch panel, the screen can be implemented as a touch screen to receive an input signal from a user. The touch panel includes one or more touch sensors to sense a touch, a swipe and a gesture on the touch panel. The touch sensor can not only sense a boundary of a touch or a swipe, but also measure duration and pressure associated with the touch or the swipe. In some examples, the multi-media component 2408 includes a front-facing camera and/or a rear-facing camera. When the apparatus 2400 is in an operating mode, such as a photographing mode or a video mode, the front-facing camera and/or the rear-facing camera can receive external multi-media data. Each of the front-facing camera and the rear-facing camera may be a fixed optical lens system or have focusing and optical zooming capabilities.

The audio component 2410 is configured to output and/or input an audio signal. For example, the audio component 2410 includes a microphone (MIC). When the apparatus 2400 is in an operating mode, such as a call mode, a recording mode or a voice recognition mode, the microphone is configured to receive an external audio signal. The received audio signal may be further stored in the memory 2404 or transmitted by means of the communication component 2416. In some examples, the audio component 2410 further includes a loudspeaker configured to output an audio signal.

The I/O interface 2412 provides an interface between the processing component 2402 and peripheral interface modules, such as keyboards, click wheels and buttons. These buttons may include but are not limited to a home button, a volume button, a start button and a lock button.

The sensor component 2414 includes one or more sensors, which are configured to provide state assessment of various aspects for the apparatus 2400. For example, the sensor component 2414 may detect a startup/shutdown state of the apparatus 2400, and relative positioning of components, which are a display and a keypad of the apparatus 2400 for instance. The sensor component 2414 may further detect a position change of the apparatus 2400 or a component of the apparatus 2400, presence or absence of a touch between a user and the apparatus 2400, an orientation or acceleration/deceleration of the apparatus 2400, and a temperature change of the apparatus 2400. The sensor component 2414 may include a proximity sensor, which is configured to detect the presence of a nearby object in the absence of any physical touch. The sensor component 2414 may further include a light sensor, such as a complementary metal oxide semiconductor (CMOS) or charge coupled device (CCD) image sensor, which are configured to be used in imaging applications. In some examples, this sensor component 2414 may further include an acceleration sensor, a gyroscopic sensor, a magnetic sensor, a pressure sensor or a temperature sensor.

The communication component 2416 is configured to facilitate wired or wireless communication between the apparatus 2400 and other devices. The apparatus 2400 may access a wireless network based on a communication standard, such as Wi-Fi, 2G, 3G, 4G LTE, 5G NR or their combinations. In an example, the communication component 2416 receives a broadcast signal or broadcast related information from an external broadcast management system by means of a broadcast channel. In an example, the communication component 2416 further includes a near-field communication (NFC) module to promote short-range communication. For example, the NFC module may be implemented on the basis of a radio frequency identification (RFID) technology, an infrared data association (IrDA) technology, an ultra wideband (UWB) technology, a Bluetooth (BT) technology and other technologies.

In an example, the apparatus 2400 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors or other electronic elements, and is configured to execute the above method for receiving a physical downlink control channel.

For example, a non-transitory computer-readable storage medium, including instructions, is further provided, such as a memory 2404, which includes instructions. The above instruction may be executed by the processor 2420 of the apparatus 2400, so as to complete the above method for receiving a physical downlink control channel. For example, the non-transitory computer-readable storage medium may be an ROM, a random access memory (RAM), a compact disc read-only memory (CD-ROM), a magnetic tape, a floppy disk or an optical data storage device, etc.

Those skilled in the art could easily conceive of other implementation solutions of the disclosure upon consideration of the description and the disclosure disclosed in the implementations. The disclosure is intended to encompass any variations, uses or adaptive changes of the disclosure, which follow the general principles of the disclosure and include common general knowledge or customary technical means, which is not disclosed in the disclosure, in the art. The description and examples are regarded as illustrative merely. The true scope and spirit of the disclosure are indicated by the following claims.

It should be understood that the disclosure is not limited to a precise structure described above and shown in accompanying drawings, and can have various modifications and changes without departing from the scope of the disclosure. The scope of the disclosure is limited by the appended claims merely.

It should be noted that relational terms such as first and second here are merely used to distinguish one entity or operation from another entity or operation without certainly requiring or implying any such actual relation or order between such entities or operations. Terms “comprise”, “include,” or their any other variations are intended to encompass non-exclusive inclusions, such that a process, method, article or device including a series of elements not only includes those elements, but also includes other elements that are not explicitly listed, or also includes inherent elements of such process, method, article or device. Under the circumstance of no more limitations, an element limited by sentence “including a . . . ” or “comprising a . . . ” does not exclude that there are other same elements in a process, a method, an article or a device including the element.

Methods and apparatuses provided in examples of the disclosure are described in detail above, specific examples are used here for illustrating the principles and implementations of the disclosure, and the description of the foregoing examples is merely used to help in understanding the method of the disclosure and core ideas of the disclosure. Moreover, those of ordinary skill in the art can make changes in terms of particular embodiments and the scope of application in accordance with the ideas of the disclosure. In conclusion, the content of the description should not be understood as limiting the disclosure.

1. A method for transmitting a physical downlink control channel, performed by a network-side device and comprising:
determining a first resource occupied by a long term evolution cell-specific reference signal (LTE CRS) and a second resource occupied by new radio physical downlink control channel (NR PDCCH) related information to be transmitted;
determining that at least one resource element (RE) in the second resource conflicts with the first resource;
adjusting the second resource and obtaining a third resource, wherein the third resource does not conflict with the first resource; and
transmitting the NR PDCCH related information to a terminal on the third resource.

2. The method according to claim 1, wherein the NR PDCCH related information comprises at least one of:
an NR PDCCH demodulation reference signal (DMRS) of an NR PDCCH; or
downlink control information (DCI) carried by the NR PDCCH.

3. The method according to claim 2, wherein in a case that the NR PDCCH related information comprises the DCI, the adjusting the second resource and obtaining the third resource comprise:
punching the second resource according to the first resource; or
carrying out rate matching on the second resource according to the first resource.

4. (canceled)

5. The method according to claim 2, wherein in a case that the NR PDCCH related information comprises the NR PDCCH DMRS, the adjusting the second resource and obtaining the third resource comprise at least one of:
changing a frequency-domain position of an RE in the second resource that conflicts with the first resource, and obtaining the third resource;
determining a time-domain symbol corresponding to the first resource in a control resource set (CORESET) where the NR PDCCH is located;
determining, in REs corresponding to the time-domain symbol, a first RE not configured to transmit the LTE CRS;
mapping a resource element group (REG) in the first RE, and determining a pattern of the NR PDCCH DMRS in the REG; and
mapping the NR PDCCH DMRS in the REG according to the pattern;
adjusting a time-domain symbol corresponding to a CORESET where the NR PDCCH is located, wherein adjusted a time-domain symbol corresponding to the CORESET is different from a time-domain symbol corresponding to the first resource; or
determining, in time-domain symbols corresponding to the second resource, a first time-domain symbol different from a time-domain symbol corresponding to the first resource, and determining a resource corresponding to the first time-domain symbol as the third resource.

6. (canceled)

7. The method according to claim 5, wherein after mapping the REG in the first RE, in a case that remaining REs are insufficient to map complete the REG, the method further comprises:
not mapping the NR PDCCH DMRS in the remaining REs; or
mapping the NR PDCCH DMRS in the remaining REs according to an existing pattern of the NR PDCCH DMRS in an existing REG structure.

8. (canceled)

9. The method according to claim 5, wherein the adjusting a time-domain symbol corresponding to the CORESET where the NR PDCCH is located comprises:
adjusting, through a specified method, a time-domain symbol corresponding to the CORESET where the NR PDCCH is located, wherein the network-side device and the terminal pre-store the specified method.

10. The method according to claim 5, further comprising:
indicating an adjusted time-domain symbol corresponding to the CORESET to the terminal via a radio resource control signaling.

11. (canceled)

12. The method according to claim 5, wherein at least one the first time-domain symbol exists in time-domain symbols corresponding to the second resource.

13. The method according to claim 5, further comprising:
indicating, via a radio resource control signaling, whether an NR PDCCH DMRS is transmitted only on a first time-domain symbol, different from a time-domain symbol corresponding to the first resource, of time-domain symbols corresponding to the second resource to the terminal; and
determining a resource corresponding to the first time-domain symbol as the third resource in a case that an NR PDCCH DMRS is transmitted only on a first time-domain symbol, different from a time-domain symbol corresponding to the first resource, of time-domain symbols corresponding to the second resource.

14. A method for receiving a physical downlink control channel, performed by a terminal and comprising:
determining a first resource occupied by a long term evolution cell-specific reference signal (LTE CRS) and a second resource occupied by new radio physical downlink control channel (NR PDCCH) related information to be transmitted;
determining that at least one resource element (RE) in the second resource conflicts with the first resource;
determining a third resource obtained after the second resource is adjusted, wherein the third resource does not conflict with the first resource; and
receiving, on the third resource, the NR PDCCH related information transmitted by a network-side device.

15. (canceled)

16. The method according to claim 14, wherein in a case that the NR PDCCH related information comprises DCI, the determining the third resource obtained after the second resource is adjusted comprises:
punching the second resource according to the first resource; or
carrying out rate matching on the second resource according to the first resource;
wherein in a case that the NR PDCCH related information comprises the NR PDCCH DMRS, the determining the third resource obtained after the second resource is adjusted comprises at least one of:
determining the third resource obtained after a frequency-domain position of an RE in the second resource that conflicts with the first resource is changed;
determining a time-domain symbol corresponding to the first resource in a control resource set (CORESET) where the NR PDCCH is located; determining, in REs corresponding to the time-domain symbol, a first RE not configured to transmit the LTE CRS; mapping a resource element group (REG) in the first RE, and determining a pattern of the NR PDCCH DMRS in the REG; and
mapping the NR PDCCH DMRS in the REG according to the pattern;
determining a CORESET after adjusting a time-domain symbol corresponding to the CORESET where the NR PDCCH is located, wherein adjusted a time-domain symbol corresponding to the CORESET is different from a time-domain symbol corresponding to the first resources; or
determining, in time-domain symbols corresponding to the second resource, a first time-domain symbol different from a time-domain symbol corresponding to the first resource, and determining a resource corresponding to the first time-domain symbol as the third resource.

17-19. (canceled)

20. The method according to claim 16, wherein after mapping the REG in the first RE, in a case that remaining REs are insufficient to map complete the REG, the method further comprises:
not expecting to receive the NR PDCCH DMRS in the remaining REs; or
receiving the NR PDCCH DMRS in the remaining REs according to an existing pattern of the NR PDCCH DMRS in an existing REG structure.

21. (canceled)

22. The method according to claim 16, wherein the determining the CORESET after adjusting a time-domain symbol corresponding to a the CORESET where the NR PDCCH is located comprises:
determining the CORESET after adjusting a time-domain symbol corresponding to the CORESET where the NR PDCCH is located through a specified method, wherein the network-side device and the terminal pre-store the specified method.

23. The method according to claim 16, further comprising:
determining, according to a radio resource control signaling transmitted by the network-side device, adjusted time-domain symbol corresponding to the CORESET.

24. (canceled)

25. The method according to claim 16, wherein at least one the first time-domain symbol exists in the time-domain symbols corresponding to the second resource.

26. The method according to claim 16, further comprising:
determining, according to a radio resource control signaling transmitted by the network-side device, whether an NR PDCCH DMRS is transmitted only on a first time-domain symbol, different from a time-domain symbol corresponding to the first resource, of time-domain symbols corresponding to the second resource; and
determining a resource corresponding to the first time-domain symbol as the third resource in a case that an NR PDCCH DMRS is transmitted only on a first time-domain symbol, different from a time-domain symbol corresponding to the first resource, of time-domain symbols corresponding to the second resource.

27.-28. (canceled)

29. A communication apparatus, comprising:
one or more processors; and
a memory for storing a computer program; wherein
the computer program when executed by the one or more processors causes the one or more processors to collectively;
determine a first resource occupied by a long term evolution cell-specific reference signal (LTE CRS) and a second resource occupied by new radio physical downlink control channel (NR PDCCH) related information to be transmitted;
determine that at least one resource element (RE) in the second resource conflicts with the first resource;
adjust the second resource and obtaining a third resource, wherein the third resource does not conflict with the first resource; and
transmit the NR PDCCH related information to a terminal on the third resource.

30. A communication apparatus, comprising:
one or more processors; and
a memory for storing a computer program; wherein
the one or more processors are collectively configured to execute the computer program, so as to perform the method for receiving the physical downlink control channel according to claim 14.

31. A non-transitory computer-readable storage medium, configured to store a computer program, wherein the computer program when executed by one or more processors cause the one or more processors to collectively execute the method for transmitting the physical downlink control channel according to claim 1.

32. A non-transitory computer-readable storage medium, configured to store a computer programs, wherein the computer program when executed by one or more processors cause the one or more processors to collectively execute the method for receiving the physical downlink control channel according to claim 14.
